(19) United States
(12) Patent Application Publication
(10) Pub. No.: US 2026/0135203 A1
(43) Pub. Date: May 14, 2026

(54) CELL POUCH FOR LITHIUM SECONDARY BATTERY CONTAINING SLIP AGENT AND METHOD OF MANUFACTURING THE SAME

(71) Applicant: DONGWON SYSTEMS CORPORATION, Seoul (KR)

(72) Inventors: Eui Hwan SONG, Seoul (KR); Sung Gi YOON, Cheonan-si (KR); Hyun Ah LEE, Sejong-si (KR); Gyu Woon JUNG, Ansan-si (KR); Jong An KIM, Sejong-si (KR); Seong Weon JANG, Suwon-si (KR); Seung Hyeon YEON, Bucheon-si (KR); Hyeong Hoon KIM, Suwon-si (KR)

(73) Assignee: DONGWON SYSTEMS CORPORATION, Seoul (KR)

(21) Appl. No.: 19/049,418

(22) Filed: Feb. 10, 2025

(30) Foreign Application Priority Data
Nov. 13, 2024 (KR) 10-2024-0161120

(51) Int. Cl. H01M 50/105; H01M 50/129

(52) U.S. Cl. CPC H01M 50/105; H01M 50/129

(57) ABSTRACT

A secondary battery cell pouch is described and disclosed. The secondary battery cell pouch comprises a substrate layer; a barrier layer; and a resin layer, wherein the substrate layer, the barrier layer and the resin layer are sequentially laminated and a slip agent is applied to the resin layer, wherein when intensity of peaks that appear when FT-IR is measured for a surface of the resin layer is A and C as follows, peak intensity ratio C/A is in the range of 0.055≤C/A≤0.150.
A: PP peak (2,917 cm⁻¹) intensity
C: Slip agent peak 2 (1,650 cm⁻¹) intensity

### CROSS-REFERENCE TO RELATED APPLICATIONS

This application claims the benefit of Korean Application No. 10-2024-0161120, filed Nov. 13, 2024, in the Korean Intellectual Property Office. All disclosures of the document named above are incorporated herein by reference.

### TECHNICAL FIELD

The present invention relates to a cell pouch for a lithium secondary battery including a slip agent and a method for manufacturing the same.

### BACKGROUND ART

With the development of portable mobile electronic devices such as smartphones, MP3 players, and tablet PCs, the demand for secondary batteries that can store electric energy is increasing explosively. In particular, the demand for secondary batteries is growing due to the emergence of electric vehicles, medium and large-sized energy storage systems, and portable devices that require high energy density.

Among these, lithium secondary batteries convert chemical energy into electrical energy, have a high energy density, and can be reused through multiple charging and discharging cycles, so they are used in various ways. Lithium secondary batteries enable the miniaturization and weight reduction of devices and are used as core components that power everything from IT devices for mobile communications to electric vehicles, as well as power sources for portable electronic devices used in modern people's daily lives.

These lithium secondary batteries comprise a cathode, an anode, an electrolyte, a separator, and an outer packaging material that packages them. The outer packaging material includes cylindrical cans, square cans, and pouches. Among these, pouches have the advantage of being easy to form into various shapes, so they are used in various ways.

On the other hand, as lithium secondary batteries become more capable, the stability of lithium secondary batteries is also being considered, and various studies are being conducted to improve the properties of pouches.

### RELATED ART

Japanese Patent Application Publication No. 2005-183820

### DISCLOSURE

### Technical Issues

The present invention provides a secondary battery cell pouch capable of improving formability including forming depth, and a method for manufacturing the same.

### Technical Solution

According to one aspect of the present invention, a secondary battery cell pouch comprises a substrate layer; a barrier layer; and a resin layer, wherein the substrate layer, the barrier layer, and the resin layer are sequentially laminated and a slip agent is applied to the resin layer, wherein when intensity of peaks that appear when FT-IR is measured for a surface of the resin layer is A and C as follows, peak intensity ratio C/A is in the range of 0.055≤C/A≤0.150.
A: PP peak (2,917 cm⁻¹) intensity
C: Slip agent peak 2 (1,650 cm⁻¹) intensity

When the intensity of the peaks that appear when FT-IR is measured for the surface of the resin layer is B and D as follows, the cell pouch may have a peak intensity ratio B/A in the range of 0.050≤B/A≤0.110, a peak intensity ratio C/A in the range of 0.055≤C/A≤0.150, and a peak intensity ratio D/A in the range of 0.040≤D/A≤0.100.
B: Slip agent peak 1 (3,300 cm⁻¹) intensity
D: Slip agent peak 3 (1,559 cm⁻¹) intensity

The resin layer is formed with a multilayer structure having two or more layers, and the slip agent may be applied to at least one of a plurality of layers forming the resin layer.

The slip agent may be one of an organic silicone slip agent or a fatty acid amide slip agent.

The slip agent may be oleamide.

According to another aspect of the present invention, a method for manufacturing the cell pouch comprises forming a laminated structure including a resin layer to which the slip agent is applied in the cell pouch; aging the cell pouch in an environment of 40 to 70 degrees Celsius for 3 to 10 days; and forming the aged cell pouch.

The resin layer constituting the cell pouch may be formed as a multilayer structure having a plurality of layers, and the slip agent may be applied to at least one layer among the plurality of layers constituting the resin layer.

The slip agent may be one of an organic silicone slip agent or a fatty acid amide slip agent.

The slip agent may be oleamide.

The slip agent may be added in an amount of 5 ppm to 100 ppm.

### Advantageous Effects

The method for manufacturing a secondary battery cell pouch according to the present invention has the effect of enabling a deeper forming depth by improving the formability of the secondary battery cell pouch using a slip agent.

### DESCRIPTION OF DRAWINGS

These and/or other aspects will become apparent and more readily appreciated from the following description of the embodiments, taken in conjunction with the accompanying drawings in which:

FIG. 1 is a graph showing the AFM (Atomic Force Microscopy) measurement values and formability evaluation results according to the maturation period of a slip agent according to one embodiment; and

FIG. 2 is a graph showing the FT-IR measurement results and peak positions of a pouch to which a slip agent is applied according to one embodiment.

### DETAILED DESCRIPTION OF EMBODIMENTS

Hereinafter, embodiments of the present invention will be described with reference to the attached drawings. Unless otherwise defined or stated, terms indicating directions used in this description are based on the state shown in the drawings. In addition, the same reference numerals refer to the same members throughout each embodiment. Meanwhile, each component shown in the drawings may have its thickness or dimension exaggerated for convenience of explanation, and it does not mean that it must be configured with the ratio between the corresponding dimensions or components in reality.

The pouch film is composed of a multilayer structure of a substrate layer, a barrier layer, and a resin layer. Each layer has a specific function. The structure of the film can be explained as follows. The substrate layer is mainly composed of a polymer film, the barrier layer is mainly composed of metal, etc., and a slip agent is not applied to the substrate layer and the barrier layer.

The resin layer mainly uses a propylene-based resin, and can be composed of one or more layers. The resin layer according to the present embodiment is described as being composed of three layers: an inner layer, a middle layer, and an outer layer. However, it is not limited thereto, and it may be composed of one or more layers.

The inner layer of the resin layer according to the present embodiment uses modified polypropylene and plays a role in increasing the adhesiveness with the barrier layer (metal layer) or other polymer layers. The middle layer is composed of a polypropylene-based resin and plays a role in improving formability and durability. The outer layer is a layer to which a slip agent is mainly applied, and can be formed of polypropylene. However, the slip agent can be included in any layer of the multilayer structure forming the resin layer. The slip agent migrates to the film surface during the maturation process to reduce friction.

Slip agents are substances that reduce friction on the surface of a film and are mainly used to improve the processability and formability of a film. In particular, in the manufacture of the outer packaging material of a pouch-type secondary battery according to the present embodiment, slip agents minimize friction that occurs during the forming of the film, enable uniform forming, and improve the quality of the film.

There is a method of using slip agents by directly mixing them in the film manufacturing process. At this time, the slip agent is manufactured into a film through an extrusion process together with a polyolefin-based resin such as polypropylene (PP). The slip agent is included in the outer layer or middle layer of the film to reduce the surface friction coefficient of the film and reduce the friction that occurs when the pouch film is pressurized during the forming process.

As an example, a method of manufacturing a pouch by adding a slip agent is as follows.

Two types of slip agents, an organic silicone slip agent, and a fatty acid amide slip agent, may be used as slip agents.

The organic silicone slip agent is a slip agent mainly composed of an organic compound based on silicone, which acts as a lubricant on the surface of the film and significantly reduces the coefficient of friction. The organic silicone slip agent has excellent durability and continues to play a role in reducing friction by remaining on the surface of the film even after forming.

Fatty acid amide slip agents are slip agents mixed with resins during film manufacturing and reduce friction as they migrate to the film surface. Oleamide and erucamide may be included.

The following tests were conducted using oleamide slip agents.

Slip agents are manufactured into films through an extrusion process with polyolefin-based resins such as polypropylene (PP). Slip agents reduce the surface friction coefficient of the film and reduce friction that occurs when the pouch film is pressurized during the forming process.

To apply the slip agent, polypropylene resin and slip agent are mixed at a certain ratio. Afterward, the mixed resin is processed into a film form by an extruder, and the film is put into a forming process to form a pouch-shaped outer packaging material.

Homopolymer polypropylene (Homo-PP), random copolymer polypropylene (Random Copolymer-PP), block copolymer polypropylene (Block Copolymer-PP), and tercopolymer polypropylene (Tercopolymer Polypropylene), etc., or a mixture thereof, can be formed.

It is preferable that the content of the slip agent used in this process is 5 ppm or more and 100 ppm or less.

It is preferable that the slip agent concentration is added at 100 ppm or less to provide an appropriate friction reduction effect on the film surface while preventing the slip agent from excessively migrating to the surface after forming and leaving residues or affecting the film surface quality. In other words, the effect on the physical properties (durability, chemical resistance, etc.) of the film is minimized while contributing to improving the formability. However, in order to exhibit a friction reduction effect, it is preferable that the slip agent is added at least 5 ppm or more.

The slip agent migrates from the inside of the film to the surface to improve the formability and lubrication properties of the film. The migration conditions vary depending on the following factors.

The temperature is maintained at 40 to 70 degrees Celsius for 3 to 10 days. At a high temperature of 100 [symbol] or higher during forming, the slip agent is rapidly migrated to the film surface, and the friction reduction effect on the surface is realized. However, at a temperature of 70 [symbol] or higher, the slip agent may be excessively migrated, and residue may be formed on the film surface after forming. Also, if the temperature is too low, the migration effect is insufficient.

In addition, if the maturation period, that is, the migration period, is too short, there is a problem that the sufficient migration effect does not occur, and if more than 10 days pass, the slip agent may be excessively accumulated, so the quality of the film may deteriorate due to the excessive friction reduction effect on the surface.

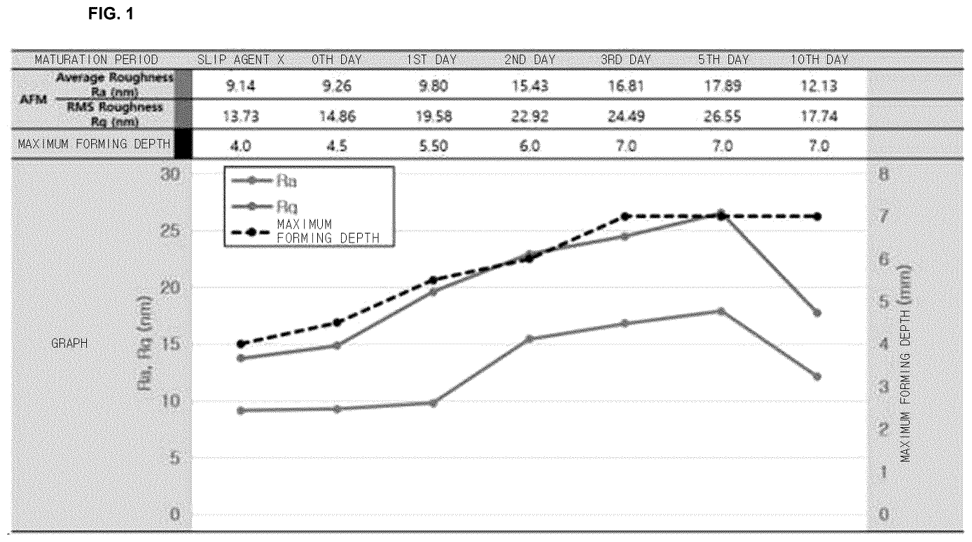

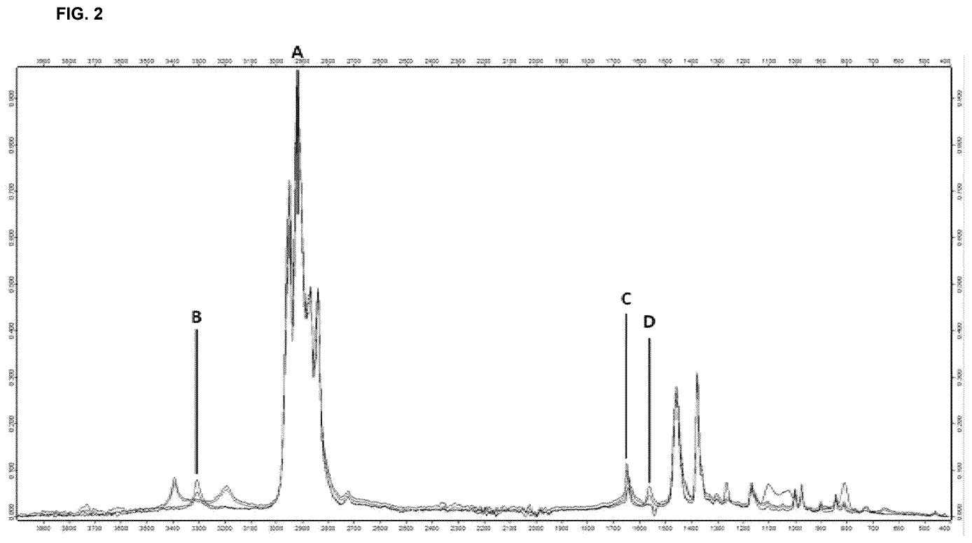

The characteristics of a pouch to which a slip agent is applied according to one embodiment will be described with reference to FIGS. 1 and 2. FIG. 1 is a graph showing the AFM (Atomic Force Microscopy) measurement values and the formability evaluation results according to the maturation period of the slip agent according to one embodiment, and FIG. 2 is a graph showing the FT-IR measurement results and peak positions of a pouch to which a slip agent is applied according to one embodiment.

Referring to FIG. 1, the AFM (Atomic Force Microscopy) measurement values and the formability evaluation results according to the maturation period of the slip agent are presented in a graph. Based on this, the correlation between the friction characteristics (Ra, Rq) and the formability (maximum forming depth) according to the maturation period can be analyzed.

Regarding Ra (Average Roughness), the Ra value is 9.14 nm in the state where the slip agent is not applied (X), and the Ra value slightly increases to 9.26 nm after 0 days in the state where the slip agent is applied.

As maturation progresses, the Ra value rapidly increases to 9.80 nm on the 1st day, 15.43 nm on the 2nd day, and 16.81 nm on the 3rd day. This can be interpreted as the result of the friction reduction effect being maximized as the slip agent is migrated to the film surface. On the 5th day, the Ra value reached its peak at 17.89 nm, and on the 10th day, it decreased to 12.13 nm.

Regarding Rq (RMS Roughness), the Rq value was 13.73 nm in the non-slip agent state, and slightly increased to 14.86 nm on the 0th day after the slip agent was applied. As the maturation progressed, it gradually increased to 19.58 nm on the 1st day, 22.92 nm on the 2nd day, and 24.49 nm on the 3rd day, showing that the migration effect was continuing. On the 5th day, the Rq value reached its maximum at 26.55 nm, and then decreased again to 17.74 nm on the 10th day.

The maximum forming depth of the film with the slip agent applied is improved according to the maturation period. When the slip agent was not applied, the forming depth was 4.0 mm, and when the slip agent was applied, the forming depth slightly increased to 4.5 mm. As maturation progressed, it rapidly increased to 5.5 mm on the 1st day, 6.0 mm on the 2nd day, and 7.0 mm on the 3rd day, and the forming depth was maintained at 7.0 mm for the 5th and 10th days, and showed almost no change thereafter.

Through this, it was found that the increase in Ra and Rq values was due to the slip agent being migrated to the surface and increasing the surface roughness of the film, thereby generating a friction reduction effect. The maximum forming depth increased in proportion to the Ra and Rq values and was maintained at 7.0 mm even after the 5th day when Ra and Rq began to decrease. This suggests that the slip agent's formability improvement effect was stably exerted during the maturation period.

Referring to FIG. 2, it can be confirmed that peaks appear at various wavelengths related to the slip agent through FT-IR (infrared spectroscopy) analysis.

FT-IR can identify the type of chemical bond within a molecule through the absorption peak of a specific wavelength that occurs when a substance absorbs or emits infrared rays. Each chemical bond has its own vibrational energy, so it exhibits its own absorption peak at a specific wavelength. Through this, it is possible to identify the type of bond and confirm the location of the functional group.

In the case of the pouch according to this example, it is possible to verify whether the slip agent is appropriately distributed within the film and whether there are any impurities through FT-IR. By evaluating the distribution status of the slip agent, it is possible to determine whether the slip agent can effectively contribute to film forming.

In addition, whether the slip agent has migrated to the film surface can also be identified through FT-IR. When the slip agent reaches the film surface, its chemical components are reflected in the FT-IR spectrum, which allows one to determine whether the slip agent has migrated. If an absorption peak of a specific bond unique to the slip agent appears on the film surface, it means that the slip agent has migrated.

In addition, since the degree of slip agent migration can be identified, it is possible to evaluate whether the slip agent has migrated well to the surface to reduce friction during the forming process. In other words, by comparing the spectra of a film with and without the slip agent using FT-IR, it is possible to identify whether the slip agent has been successfully mixed into the film. If a specific chemical bond of the added slip agent appears in the spectrum, it indicates that the slip agent has been well distributed in the film.

TABLE 1

| | | | | | Comparative | Comparative | Comparative | Comparative |
|---|---|---|---|---|---|---|---|---|
| | Example 1 | Example 2 | Example 3 | Example 4 | Example 1 | Example 2 | Example 3 | Example 4 |
| Maximum | 4.5 | 4 | 5.5 | 6 | 7 | 7 | 7 | 6 |
| Forming Depth | | | | | | | | |
| (mm) | | | | | | | | |
| B/A | 0.028 | 0.032 | 0.045 | 0.051 | 0.053 | 0.071 | 0.081 | 0.118 |
| C/A | 0.019 | 0.030 | 0.047 | 0.053 | 0.059 | 0.077 | 0.085 | 0.177 |
| D/A | 0.016 | 0.022 | 0.034 | 0.039 | 0.044 | 0.058 | 0.064 | 0.107 |
| FT-IR | | | | | | | | |
| PP | 0.896 | 0.893 | 0.921 | 0.933 | 0.982 | 0.887 | 0.835 | 0.652 |
| peak(2,917)-A | | | | | | | | |
| Slip Agent | 0.025 | 0.029 | 0.041 | 0.048 | 0.052 | 0.063 | 0.068 | 0.077 |
| Peak1(3,300)-B | | | | | | | | |
| Slip Agent | 0.017 | 0.027 | 0.044 | 0.049 | 0.058 | 0.068 | 0.071 | 0.116 |
| Peak2(1,650)-C | | | | | | | | |
| Slip Agent | 0.014 | 0.020 | 0.032 | 0.037 | 0.043 | 0.051 | 0.053 | 0.070 |
| Peak3(1,559)-D | | | | | | | | |

Table 1 shows the results of FT-IR analysis of comparative examples and examples.

Looking at Table 1 and FIG. 2, the following is shown. The x-axis of FIG. 2 represents wavenumber (unit: cm¹), and the y-axis represents absorbance.

The important peaks are as follows:
A: 2917 cm⁻¹: A peak corresponding to the C—H bond of polypropylene (PP), indicating that PP is the main component of the film.
B: 3300 cm⁻¹: Peak 1 intensity of the slip agent
C: 1650 cm⁻¹: Peak 2 intensity of the slip agent, which corresponds to a specific bond (mainly C═O bond)
D: 1559 cm⁻¹: Peak 3 intensity of the slip agent

A, B, C, and D are defined as peak intensities at the corresponding wavenumbers, respectively. The ratio of each peak intensity (A, B, C, D) can be used to determine how much of the slip agent has been migrated to the surface. The correlation between the slip agent and PP can be analyzed through the following ratios.

C/A ratio: The ratio of the slip agent peak 2 (1650 cm⁻¹) and the PP peak (2917 cm⁻¹), which indicates how much the slip agent has migrated to the surface. The range of 0.055≤C/A≤0.150 indicates ideal cell pouch properties.

B/A ratio: The ratio of the slip agent peak 1 (3300 cm⁻¹) and the PP peak (2917 cm⁻¹), which indicates appropriate formability when this value is in the range of 0.050≤B/A≤0.110.

D/A ratio: The ratio of the slip agent peak 3 (1559 cm⁻¹) and the PP peak (2917 cm⁻¹), which indicates that the range of 0.040≤D/A≤0.100 is appropriate.

For example, in Example 1, the forming depth is 7 mm, the B/A ratio is 0.053, and the C/A ratio is 0.059, which are within the ideal range. This shows that the slip agent was properly migrated to the surface, and as a result, the formability was optimized.

In this way, the interaction between the slip agent and PP is analyzed through the peak intensity ratio, and by reflecting this on the formability, the slip agent concentration and surface migration state that show the optimal performance can be confirmed. The performance of the slip agent can be evaluated through the forming depth and FT-IR peak intensity ratio of each pouch, and the formability of the film can be predicted accordingly.

On the other hand, when only peaks A and C are shown, it means that only some components of the slip agent were shown, and only the slip agent mainly of carbonyl (C═O) bonds was migrated to the surface. It is possible that only some of the functions of the slip agent were exerted, and the migration was not completely achieved, or only a specific component of the slip agent was migrated to the surface.

In contrast, when peaks A, B, C, and D all appear, it indicates that various components of the slip agent were migrated to the surface. This means that the slip agent can maximize the effect on the film's formability. It is highly probable that the entire components of the slip agent are evenly distributed on the film surface, and both the formability and friction reduction effects are exerted. As the components of the slip agent are completely migrated, the film's forming depth and durability are highly probable to be optimized. This can particularly contribute greatly to the performance of pouch films that require deep forming.

Although the preferred embodiments of the present invention have been described above, the technical idea of the present invention is not limited to the preferred embodiments described above, and can be implemented in various ways within a scope that does not deviate from the technical idea of the present invention embodied in the patent claims.

1. A secondary battery cell pouch comprising:
a substrate layer;
a barrier layer; and
a resin layer,
wherein the substrate layer, the barrier layer and the resin layer are sequentially laminated and a slip agent is applied to the resin layer,
wherein when intensity of peaks that appear when FT-IR is measured for a surface of the resin layer is A and C as follows, peak intensity ratio C/A is in the range of 0.055≤C/A≤0.150.
A: PP peak (2,917 cm⁻¹) intensity
C: Slip agent peak 2 (1,650 cm⁻¹) intensity

2. The secondary battery cell pouch of claim 1, wherein when the intensity of the peaks that appear when FT-IR is measured for the surface of the resin layer is B and D as follows, the cell pouch has a peak intensity ratio B/A in the range of 0.050≤B/A≤0.110, a peak intensity ratio C/A in the range of 0.055≤C/A≤0.150, and a peak intensity ratio D/A in the range of 0.040≤D/A≤0.100.
B: Slip agent peak 1 (3,300 cm⁻¹) intensity
D: Slip agent peak 3 (1,559 cm⁻¹) intensity

3. The secondary battery cell pouch of claim 1, wherein the resin layer is formed with a multilayer structure having two or more layers, and the slip agent is applied to at least one of a plurality of layers forming the resin layer.

4. The secondary battery cell pouch of claim 1, wherein the slip agent is one of an organic silicone slip agent and a fatty acid amide slip agent.

5. The secondary battery cell pouch of claim 4, wherein the slip agent is oleamide.

6. A method for manufacturing the cell pouch according to claim 1, comprising:
forming a laminated structure including a resin layer to which the slip agent is applied in the cell pouch;
aging the cell pouch in an environment of 40 to 70 degrees Celsius for 3 to 10 days; and
forming the aged cell pouch.

7. The method of claim 6, wherein the resin layer constituting the cell pouch is formed as a multilayer structure having a plurality of layers, and the slip agent is applied to at least one layer among the plurality of layers constituting the resin layer.

8. The method of claim 6, wherein the slip agent is one of an organic silicone slip agent or a fatty acid amide slip agent.

9. The method of claim 8, wherein the slip agent is oleamide.

10. The method of claim 9, wherein the slip agent is added in an amount of 5 ppm to 100 ppm.

11. The secondary battery cell pouch of claim 2, wherein the resin layer is formed with a multilayer structure having two or more layers, and the slip agent is applied to at least one of a plurality of layers forming the resin layer.

12. The secondary battery cell pouch of claim 2, wherein the slip agent is one of an organic silicone slip agent and a fatty acid amide slip agent.

13. The secondary battery cell pouch of claim 12, wherein the slip agent is oleamide.

14. A method for manufacturing the cell pouch according to claim 2, comprising:
forming a laminated structure including a resin layer to which the slip agent is applied in the cell pouch;
aging the cell pouch in an environment of 40 to 70 degrees Celsius for 3 to 10 days; and
forming the aged cell pouch.

15. A method for manufacturing the cell pouch according to claim 3, comprising:
forming a laminated structure including a resin layer to which the slip agent is applied in the cell pouch;
aging the cell pouch in an environment of 40 to 70 degrees Celsius for 3 to 10 days; and
forming the aged cell pouch.

16. A method for manufacturing the cell pouch according to claim 4, comprising:
forming a laminated structure including a resin layer to which the slip agent is applied in the cell pouch;
aging the cell pouch in an environment of 40 to 70 degrees Celsius for 3 to 10 days; and
forming the aged cell pouch.

17. A method for manufacturing the cell pouch according to claim 5, comprising:
forming a laminated structure including a resin layer to which the slip agent is applied in the cell pouch;
aging the cell pouch in an environment of 40 to 70 degrees Celsius for 3 to 10 days; and
forming the aged cell pouch.

18. A method for manufacturing the cell pouch according to claim 11, comprising:
forming a laminated structure including a resin layer to which the slip agent is applied in the cell pouch;
aging the cell pouch in an environment of 40 to 70 degrees Celsius for 3 to 10 days; and
forming the aged cell pouch.

19. A method for manufacturing the cell pouch according to claim 12, comprising:
forming a laminated structure including a resin layer to which the slip agent is applied in the cell pouch;
aging the cell pouch in an environment of 40 to 70 degrees Celsius for 3 to 10 days; and
forming the aged cell pouch.

20. A method for manufacturing the cell pouch according to claim 13, comprising:
forming a laminated structure including a resin layer to which the slip agent is applied in the cell pouch;
aging the cell pouch in an environment of 40 to 70 degrees Celsius for 3 to 10 days; and
forming the aged cell pouch.
